(19) United States
(12) Patent Application Publication
(10) Pub. No.: US 2016/0321118 A1
(43) Pub. Date: Nov. 3, 2016

(54) COMMUNICATION SYSTEM, METHODS AND APPARATUS FOR INTER-PARTITION COMMUNICATION

(71) Applicant: FREESCALE SEMICONDUCTOR, INC., Austin, TX (US)

(72) Inventors: Cristian Constantin Solvaiala, Voluntari (RO); Madalin-Cristian Buccur, Costinesti (RO)

(21) Appl. No.: 15/103,578

(22) PCT Filed: Dec. 12, 2013
(86) PCT No.: PCT/IB2013/060860

§ 371 Date: Jun. 10, 2016

(51) Int. Cl. G06F 9/54

(52) U.S. Cl. CPC G06F 9/544; G06F 9/546

(57) ABSTRACT

A communication system comprises a plurality of software partitions operably coupled to one another via at least one hardware module, wherein each of the plurality of software partitions comprises memory allocated to store data for use solely by the respective software partition, wherein the hardware module is arranged to copy data from a first memory location of a first software partition to second memory location of a second software partition wherein the second memory location is selected by the second software partition.

### FIELD OF THE INVENTION

This invention relates to a communication system and methods and apparatus for inter-partition communication, and in particular to a hardware module and a method of transferring data between software partitions to increase efficiency of inter-partition communication.

### BACKGROUND OF THE INVENTION

Multi-core processors are single processing components that comprise two or more independent processor cores, which are manufactured on the same integrated circuit die or as separate microprocessor dies in the same package. Independent processor cores can advantageously run separate instructions in parallel, thereby increasing overall speed of the multi-core processor. A multi-core processor generally includes two or more logical partitions, which allows hardware resources to be divided between specific cores. The interaction between the different partitions and applications running on the multi-core processor are often managed by a hypervisor. A hypervisor organises a virtual operating platform and manages the execution of multiple operating systems running in parallel on the multi-core processor.

Communication is generally necessary between different partitions, referred to as inter-partition communication. Inter-partition communication is generally implemented through a memory area that is shared between sending and receiving partitions.

However, memory sharing reduces isolation of the partitions and increases the risk to security, especially if the inter-partition communication opens up direct private memory access between the partitions. Further, sharing of memory can cause system recovery issues in case of failure of partition(s). In some instances, these risks can be managed by a hypervisor, which mediates every inter-partition communication. However, the use of a hypervisor can impose significant overhead and make communications between partitions slow.

Referring to FIG. 1, from US2013/0227243A1, a known multi-core processor 100 is illustrated having logical partitions 102, 104 and 106 and a hypervisor 108. The logical partitions 102, 104, 106 have respective processor cores 112, 114, 116, 118 and private memory areas 120, 122 and 124. System hardware 110 comprises shared memory 134, which is shared between logical partitions 102, 104 and 106.

The known multi-core processor 100 illustrated in FIG. 1, relies on hypervisor 108 and shared memory 134 to achieve inter-partition communication. In some cases, the software partitions 102, 104, 106 will be in control of both source and destination addresses of the memory regions, for example private memory 120, 122, 124, used in the transfer. At least one of these destination addresses belongs to the memory of another software partition. Therefore, there is an increased risk of security issues arising when utilising a shared memory approach, wherein each partition 102, 104, 106 is aware of the destination address of the resultant transmitted data.

Further, data transfer is carried out by the software partitions 102, 104, 106, thereby resulting in increased central processing unit (CPU) cycles being utilised.

Furthermore, the use of a hypervisor, such as hypervisor 108, increases the complexity of the multi-core processor 100.

In other known multi-core processors, a direct memory access (DMA) controller may be utilised to transfer data between software partitions. In DMA cases, the DMA controller needs to be programmed for each and every data transfer, utilising processor power. Further, a sending/controlling software partition needs to be aware of the destination memory address of a relevant receiving partition. Therefore, in DMA cases, there is no isolation between sending and receiving memory partitions, which may lead to security issues. Furthermore, DMA controllers require a shared memory space between memory partitions. Therefore, sending and receiving partitions are able to access the shared memory region. Generally, the shared memory area would be mapped by each software partition so that it can be accessed. As a result, a number of software copy operations of data are made by the software partitions. The sending partition would copy data from its private memory space to the shared memory region. The receiving partition would then copy the data from the shared memory region to its private memory space. This process can cause synchronisation issues between memory partitions.

Thus, the use of shared memory regions significantly slows down transfer operations between software partitions. This is generally because of the need to support software copy operations made by transmitting and receiving partitions, accompanied by mapping operations of shared memory blocks.

### SUMMARY OF THE INVENTION

The present invention provides a communication system and method of transferring data as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a block diagram of a known multi-core processor.

FIG. 2 schematically shows an example block diagram of an inter-partition communication system.

FIG. 3 schematically shows an example block diagram of a further inter-partition communication system.

FIG. 4 schematically shows an example block diagram of a buffer draining operation.

FIG. 5 schematically shows an example block diagram of an alternative buffer draining operation.

FIG. 6 schematically shows an example block diagram of a simplified buffer operation.

FIG. 7 schematically shows an example block diagram of input and output queues of an inter-partition communication system.

FIG. 8 illustrates a flow chart of an example of a simplified hardware module configuration operation.

FIG. 9 schematically shows a block diagram of an example memory exchange between software partitions within a communications system.

FIG. 10 illustrates an example flow chart of inter-partition communication between software partitions.

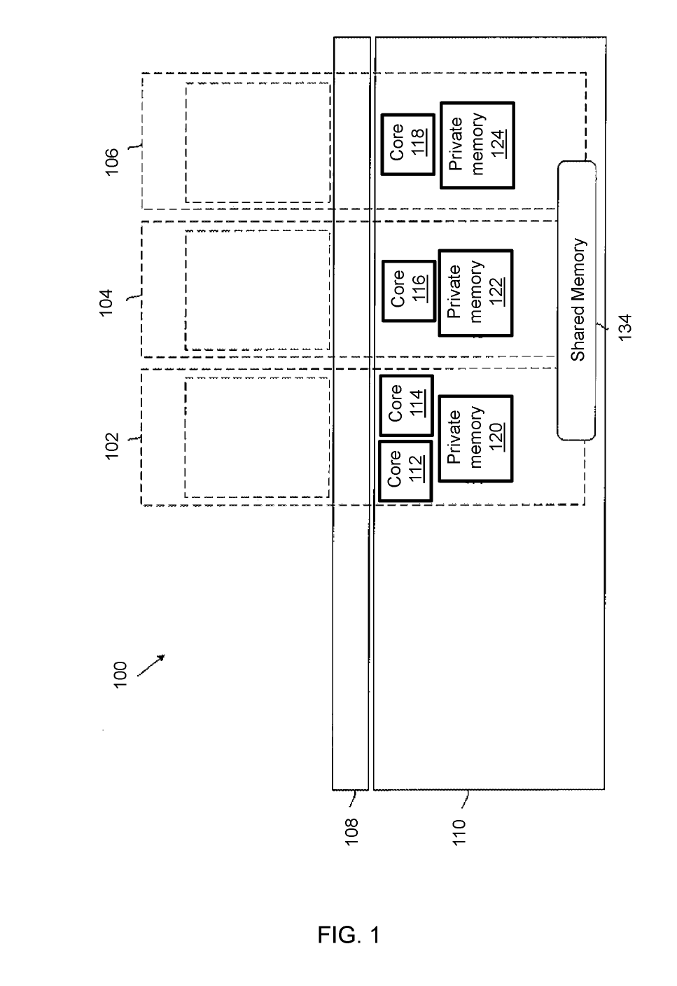

### DETAILED DESCRIPTION

Because the illustrated embodiments of the present invention may, for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

Although examples of the invention are described with reference to multiprocessor systems that require local software partitions, it is envisaged that the inventive concept may be employed in any communication system that comprises software partitions that require data communication there between.

Examples of the invention use the terms ‘copy’ and ‘replicate’ interchangeably, particularly with respect to transferring data to more than one destination queue(s) and/or buffer(s).

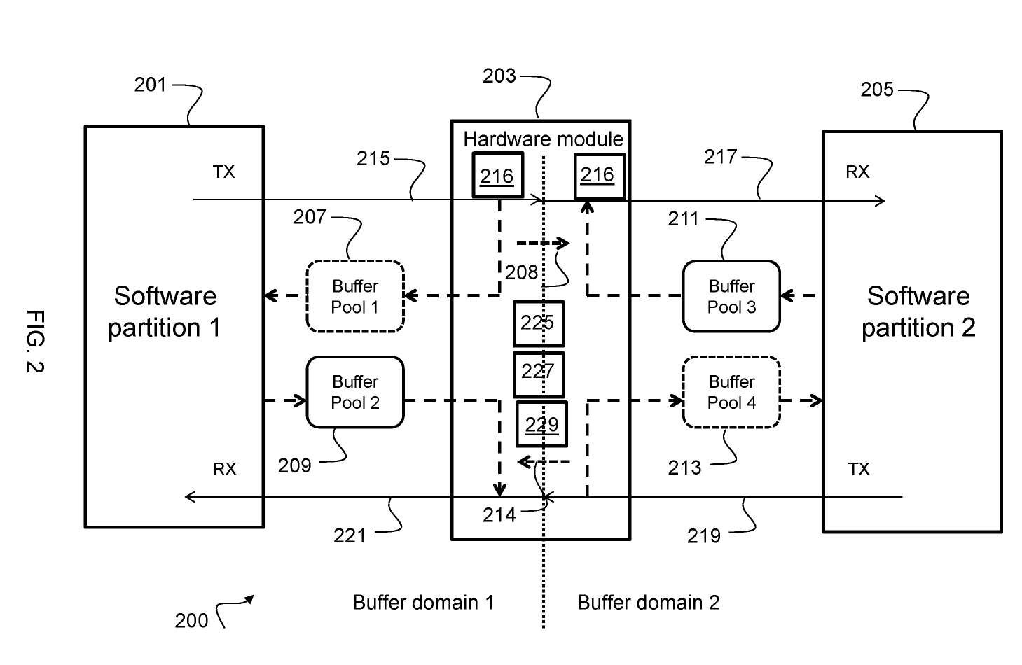

Referring to FIG. 2, a block diagram 200 illustrates a simplified example of inter-partition communication comprising, a first software partition 201, a hardware module 203 and a second software partition 205. In this example, the first software partition 201 and second software partition 205 communicate with each other via the hardware module 203. In some examples, the software partitions 201 and 205 may be partitions in a virtualized scenario (when multiple operating systems run on top of a hypervisor) or may be purely software entities, for example as part of an application running within an operating system featuring, say memory protection. In some examples, the hardware module 203 may form part of a series of hardware accelerators, which, for example, may be implemented within a system on a chip (SoC) architecture (such as a microcontroller or a digital signal processor comprising multiple cores) that may have the ability to transfer data between different software partitions, for example first software partition 201 and second software partition 205. Further, in some examples the hardware module 203 may be an offline parsing port comprising communications hardware. In some examples, the hardware module 203 may be a hardware component, for example the offline parsing port, that facilitates data transfers with optional features, such as parsing, classifying and distributing of data frames.

In this example, the first software partition 201 comprises or is associated with a first buffer pool 207 and a second buffer pool 209. Further, second software partition 205 comprises or is associated with a third buffer pool 211 and a fourth buffer pool 213. In the description hereafter, the term ‘comprising’ when used in the context of software partitions comprising one or more buffer pool(s) encompasses software partitions being associated with and operably coupled to their respective one or more buffer pool(s), in addition to the buffer pool forming a part of the software partition in some examples. Each of the buffer pools 207, 209, 211 and 213 comprise a collection of memory regions, referred to as buffers, each of which may have similar characteristics. The buffer pools 207, 209, 211 and 213 may be configured by the relevant software partition 201, 205 and populated/filled with buffers allocated by the software partitions 201, 205. Further, the relevant software partitions 201, 205 may allocate individual buffers and insert buffer descriptors into one or more buffer pools 207, 209, 211 and 213. As such, buffer pools 207, 209, 211 and 213 may be considered as a collection of references to one or more buffers. In some examples, the buffer pools 207, 209, 211 and 213 may need to be configured by relevant software partitions 201, 205, and populated with one or more buffer descriptors, before the buffer pools 207, 209, 211 and 213 are able to be utilised by hardware, for example hardware module 203, and software (not shown).

In some examples, the buffers within the buffer pools 207, 209, 211 and 213, may be situated within a region of contiguous memory, which may be allocated by software partitions 201, 205 and used for data storage during communications.

In some other examples, the buffers within the buffer pools 207, 209, 211 and 213 may be situated in distinct, separate and/or special purpose memory areas allocated by the software partitions 201, 205, which may not be in a contiguous memory region.

In order for the first software partition 201 and second software partition 205 to be able to communicate with each other, via the hardware module 203, queues and buffer pools 207, 209, 211 and 213 may need to be configured.

In this example, the hardware module 203 may be operable to fetch data from the first software partition 201 utilising one or more input queue(s) 215, and output a copy of the fetched data utilising one or more output queue(s) 217, which may be associated with one or more buffer pools. A routing module 216 inside the hardware module may be operable to route the data from the one or more input queue(s) 215, to the specific one or more output queue(s) 217 and associated buffer pools based on a preconfigured set of instructions. The input queue(s) 215 and output queue(s) 217, buffer pools 207, 209. 211 and 213 and the preconfigured set of instructions form an initial configuration for inter-partition communication in this example.

In some examples, the input queue(s) 215 and output queue(s) 217 that form one or more communication channels between software partitions 201, 205 and the hardware module 203, may comprise of a set of frame queues managed by a queue manager (QMan) module 225. Initialisation of queues 215, 217 and matching between frame queues of software partitions 201, 205 and frame queues of the hardware module 203 may be made from software utilising configuration files and code that may initialise queues and the hardware module.

In one example, the first software partition 201 initialises a communications interface with hardware module 203, and allocates the one or more input queue(s) 215 through which it may communicate with the hardware module 203. The first software partition 201 may also be required to communicate the one or more output queue(s) 217 to the hardware module 203. As a result, the second software partition 205 may be required to allocate the one or more output queue(s) 217 in order to receive communications from the hardware module 203. In this example, the second software partition 205 may be operable to allocate buffers and group them in a desired buffer pool, which, in this example, may be the third buffer pool 211. Therefore, in this example, the one or more output queue(s) 217 may be associated with the third buffer pool 211.

As the first software partition 201, in this example, is operable to transmit data to the hardware module 203, the first software partition 201 may be operable to configure the hardware module 203 with a set of instructions. These instructions instruct the hardware module 203 to utilise certain queues and buffer pools within the software partitions 201, 205 in order to transfer the required data. Further, the instructions can utilise different criteria, for example internet protocol (IP) addresses, medium access control (MAC) addresses, virtual local area network (VLAN) tags etc.

In this example, queues 215, 217 and buffer pools 207, 209, 211 and 213 may be identified by unique identifiers. Further, each software partition, 201, 205 may ‘own’ one or more queues 215, 217 and buffer pools 207, 209, 211, 213. For example, the first software partition 201 may ‘own’ the first buffer pool 207, the second buffer pool 209 and input queue 215, and the second software partition 205 may own the third buffer pool 211, the fourth buffer pool 213 and output queue 217. In the context of this example, the term ‘own’ encompasses a scenario whereby the queues and/or buffer pools may be individually associated with and configured by a respective software partition.

In this example, the set of instructions may comprise information that allows the first software partition 201 to write classification rules for the hardware module 203, and may comprise instructions configuring the hardware module 203 to transfer data between physical memory locations. Further, the software partition configuring the hardware module 203, in this example the first software partition 201, may also be required to communicate the required input queue(s) 215 and output queue(s) 217 to the hardware module 203, wherein the input queue(s) 215 and output queue(s) 217 represent the communication channel between the software (partitions) and the hardware (module).

In this example, communications between the first software partition 201, the hardware module 203 and the second software partition 205 may be performed utilising basic transfer units, for example datagrams. The payload of the datagrams may comprise high level destination addressing information, for example IP or MAC addresses.

In some examples, the first software partition 201 may prepare a datagram to be transmitted together with a set of parameters. These parameters may comprise information relating to an input queue to be used, in order to allow the first software partition 201 to communicate with the hardware module 203, and to a buffer pool, for example the first buffer pool 207, that is to be utilised for storing used buffers after the communication. In this example, the transmitting partition, in this case the first software partition 201, may acquire a buffer descriptor for storing information to be transmitted to the second software partition 205. In this example, the first software partition 201 may acquire a buffer descriptor from the first buffer pool 207, prior to transmitting the information to the hardware module 203.

In some examples, once the first software partition 201 has prepared and transmitted the datagram(s) together with the set of parameters to the hardware module 203, the hardware module may apply the previously received classification rules, which may have been transmitted in some examples during a classification phase of operation, in order to distribute the data to relevant output queue(s), for example output queue 217, which in some examples may have also been communicated to the hardware module 203 during the classification phase of operation. In this example, the hardware module 203 may fetch the data pointed to by the first software partition 201, make a copy of the data 208, and distribute the copied data, via output queue 217, to a buffer acquired from the third buffer pool 211. In this example, the distribution of data may be based on the hardware module 203 matching various rules to parts of the datagram payload. An advantage of this procedure is that the hardware module 203 is responsible for copying the data, not the software partitions 201, 205. Therefore, this process may offload processing from a CPU to hardware module 203.

Once the hardware module 203 has stored the copied data in the buffer acquired from the third buffer pool 211, and the data is ready to be processed by software, the hardware module 203 may issue an interrupt to the receiving partition. In this example, the second software partition 205, notifying the second software partition 205 that data is available. The interrupt may comprise a reference to the third buffer pool 211 and a memory location of the buffer with the stored data. The second software partition 205 may then access the buffer originating from the third buffer pool 211 and process the stored data. Subsequently, the second software partition 205 may release the buffer back into the third buffer pool 211, which may not require any additional processing, for example memory mapping or copying of the data. In some examples, the receiving partitions 205 and 201 may utilise a ‘polling’ method in order to poll, and subsequently operate with, buffers provided by the hardware module 203 filled with copied information, and buffers that were fetched by the hardware module 203 from the third and second buffer pools 211, 209 respectively.

In the abovementioned examples, the first software partition 201 has been shown to initiate communications with the second software partition 205 via the hardware module 203. It should be noted that this is merely for explanatory purposes, and it is equally possible for the second software partition 205 to initiate communications with the first software partition 201 via the hardware module 203. For example, the second software partition 205 may initially initialise a communications interface with hardware module 203, and allocate one or more input queue(s) 219 through which it may communicate with the hardware module 203. As a result, the first software partition 201 may be required to allocate the one or more output queue(s) 221 in order to receive communications from the hardware module 203. In some examples, the first software partition 201 may also be operable to allocate buffers and group them in a desired buffer pool, which may be second buffer pool 209. Therefore, in this manner, the one or more output queue(s) 221 may be associated with the second buffer pool 209.

In this example, the second software partition 205 may be operable to configure the hardware module 203 with a set of instructions, which may instruct the hardware module 203 to utilise certain queues and buffer pools within the software partitions 201, 205, in order to transfer a copy of the required data stored in the fourth buffer pool 213, for example. As in the previous examples, the instructions may utilise different criteria, for example IP addresses, MAC addresses, VLAN tags etc.

In this manner, communication between different software entities (e.g. first software partition 201 and second software partition 205) ensures that data is transferred by hardware (e.g. hardware module 203), whereby no shared memory region is required by the software partitions.

In some examples, the software partitions, 201, 205, may be required to configure their own queues, for example frame queues, and register callback functions, if data is available. The first and second software partitions 201, 205 may communicate the frame queues to a queue manager (QMan) 227, whereby the hardware module 203 may be configured based on the frame queues. Once frame queues have been setup, these queues may be reserved for use by the first software partition 201 or second software partition 205 and/or hardware module 203. Further, first software partition 201 and/or second software partition 205 may utilise one or more memory allocators to provide buffer pools with information, which may comprise buffer descriptors, regarding where data is going to be filled in by the hardware module 203.

In this example, the second software partition 205 may prepare a datagram to be transmitted with a set of parameters, which may comprise information relating to input queue 219 and fourth buffer pool 213, which may be utilised for storing used buffers after transmission. In some other examples, if the fourth buffer pool 213 has not been allocated by the second software partition, then the fourth buffer pool 213 may be utilised by the hardware module 203 in order to release incoming buffers to it.

In some examples, once the second software partition 205 has prepared and transmitted the datagram(s), optionally together with the set of parameters, the hardware module 203 may insert a descriptor for the buffer used in the fourth buffer pool 213, for example, and apply the previously received classification rules, which may have been transmitted during a classification phase, to distribute the data to relevant output queue(s) for example output queue 221, which may have been communicated to the hardware module 203 during the classification phase. In this example, the hardware module may fetch the data pointed to by the second software partition 205, make a copy of the data 214, and distribute the copied data via output queue 221, utilising a buffer fetched from the second buffer pool 209. The distribution of datagrams may be based on the hardware module 203 matching various rules to parts of the datagram payload.

Again, in some examples and once the hardware module 203 has stored the copied data in a buffer sourced/fetched from the second buffer pool 209, and the data is ready to be processed by software, the hardware module 203 may issue an interrupt to the receiving partition, in this example, the first software partition 201, notifying the first software partition 201 that data is available. In some examples, the interrupt may comprise a reference to the second buffer pool 209 and a memory location of the buffer with the stored data. The first software partition 201 may then access the buffer originating from the second buffer pool 209 and process the stored data. Subsequently, the first software partition 201 may release the buffer back into the second buffer pool 209, which may not require any additional processing, for example memory mapping or copying of the data.

In some examples, the software module 205 may utilise a ‘polling’ method in order to poll hardware module 203 as to determine its status, and subsequently operate (receive frames) with buffers sourced from buffer pool 211.

In this manner, an improved inter-partition communication system is provided that may provide at least one of: improved efficiency, increased isolation between software partitions, less complexity.

In some examples of FIG. 2, it may be possible for first software partition 201 and/or second software partition 205 to acquire buffers from the first buffer pool 207 and fourth buffer pool 213 respectively. Therefore, in some examples, buffers may be ‘removed’ from these buffer pools to be utilised for data storage for transmission. After transmission has been effected, the hardware module 203 may release buffers back into these buffer pools 207, 213.

However, in some other examples, the first software partition 201 and/or second software partition 205 may utilise buffers that are not acquired from the buffer pool used for storing the buffers after transmission. Therefore, buffers from buffer pools 207, 213 may not be constantly ‘removed’. Further, in some examples, the hardware module 203 may still release utilised buffers back into first buffer pool 207 and fourth buffer pool 213 after transmission. Therefore, these buffer pools 207, 213 could effectively ‘overflow’ with buffers.

In these cases, in some examples, it may be advantageous for the first software partition 201 and/or second software partition 205 to perform a ‘draining’ operation, for example to periodically drain (de-allocate) buffers from these buffer pools 207, 213 in order to prevent an overflow. A draining operation that may be required has been illustrated by the dotted lines surrounding first and fourth buffer pools 207, 213.

One benefit of each of first and second software partitions 201, 205 allocating and owning their own buffer pool buffers, for example the first software partition 201 allocating and owning the first buffer pool 207 and second buffer pool 209, and the second software partition 205 allocating and owning the third buffer pool 211 and fourth buffer pool 213, may be that each software partition 201, 205 only needs to access their respectively owned buffer pools. Therefore, each software partition 201, 205 may only need to access buffers located in its own buffer pools, and not be required to access neighbouring buffers from a different software partition.

Therefore, in this example, access to each partition's buffers may be prevented, except for the partition that actually owns the buffer pools. For example, the first software partition 201 may only be able to access the first buffer pool 207 and second buffer pool 209, and the second software partition 205 may only be able to access the third buffer pool 211 and the fourth buffer pool 213.

In some examples, a further advantage may be that each software partition 201, 205 does not need to know the destination memory address of the transmitted data during communication. For example, the first software partition 201 may initiate communication with the hardware module 203, and supply information regarding which input and output queues to utilise. In response to this information, the second software partition 205 may be operable to allocate buffers and group them in a desired buffer pool. Therefore, in this example, the memory address for storing transmitted and received data is only known by the software partition that owns the buffers utilised for storing the respective data.

A yet further advantage, in some examples, may be that the copy operation is only performed by the hardware module 203. For example, the first software partition 201 stores data to be transmitted by allocating new buffers from its memory space or re-using buffers from one of its buffer pools, for example the first buffer pool 207. The hardware module then copies this data to a memory area, for example buffers in the third buffer pool 211, of the second software partition 205. The second software partition 205 is then operable to access this data. The second software module 205 does not need to copy the data stored in the buffer fetched from the third buffer pool 211 into its private memory, because the third buffer pool 211 buffers reside within the second software partition's memory domain and, therefore, is in effect private memory. Similarly, the first software partition 201 does not need to copy the data to be transmitted from its private memory, as the hardware module 203 may copy data from private memory in the first software partition 201 and store it in a private memory within the second software partition 205. Therefore, a number of potential copy operations is reduced as compared to, say, DMA functionality, wherein the software partitions have to copy data to and from a shared memory. As this functionality is generally performed in software, increased CPU usage is required. However, in accordance with examples of the invention, the copy operations may be carried out by the hardware module 203, thereby offloading copy operations from software entities, and thereby reducing CPU usage and increasing efficiency and simplicity.

In some examples, the first and second software partitions 201, 205 may comprise software modules that reside in the software partitions 201, 205. These software modules may interact with software partitions 201, 205 via hardware interfaces, for example software portals, that may offer interrupt based or polling based methods of receiving or sending frames. Further, these software portals may comprise special insert and remove functions for operating with buffer pools.

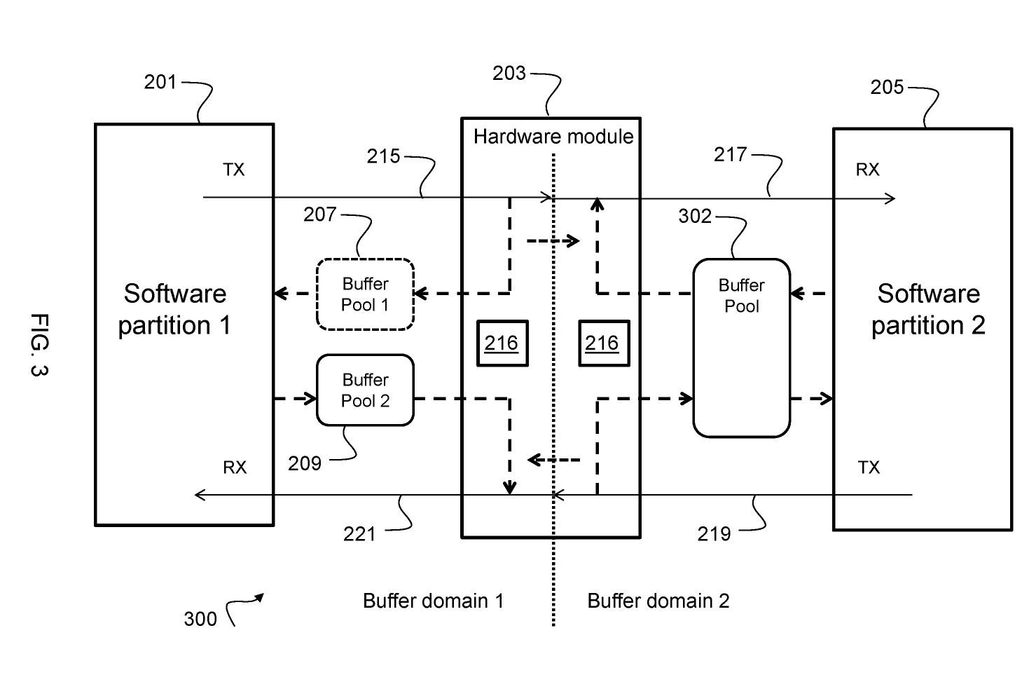

Referring now to FIG. 3, block diagram 300 illustrates a further simplified example of inter-partition communication. In this example, the structure and operation of block diagram 300 is in a number of regards the same as the structure and operation of block diagram 200 illustrated in FIG. 2. Therefore, only additional features of the block diagram 300 of FIG. 3 will be explained in detail.

In this example, the second software partition 205 comprises a single buffer pool 302, which is configured for both receive and transmit frames, rather than comprising a set of individual buffer pools, for example third buffer pool 211 and fourth buffer pool 213 of FIG. 2. In some examples, in order for buffer pool 302 to be utilised for receive and transmit frames, the buffers utilised in buffer pool 302 may all need to be substantially the same size, otherwise, buffers used for transmit frames may, say, need to be large enough to accommodate any size of receive frames.

In some examples, a benefit provided by single buffer pool 302 may be that the second software partition 205 may be required to carry out fewer operations on the buffer pool 302, as there may be a requirement to perform fewer draining and refilling operations when compared to utilising a plurality of buffer pools for a particular software partition. For example, the second software partition 205 may only utilise buffer pool 302 for allocation of buffers. As a result, when the hardware module 203 releases buffers back to buffer pool 302, there may not be an overflow as the second software partition may have previously removed buffers that may have otherwise caused an overflow.

Similarly, and in other examples, the first software partition 201 may also utilise a single buffer pool (not shown), which may function in a similar manner to buffer pool 302. Further, in other examples, the first software partition 201 may also utilise a single buffer pool in combination with a plurality of buffer pools being employed in the second software partition, for example third buffer pool 211 and fourth buffer pool 213.

Referring back to FIG. 2, the first buffer pool 207 and the fourth buffer pool 213 have been illustrated with a dotted outline. In the example of FIG. 2, the first buffer pool 207 buffers may have been acquired and utilised to store data to be copied by the first software partition 201, and the fourth buffer pool 213 buffers may have been acquired and utilised to store data to be copied by the second software partition 205. In particular examples of FIG. 2 and FIG. 3, the dotted lines surrounding the first buffer pool 207 and third buffer pool 211 may illustrate that, depending on the scenario, the first software partition 201 may periodically drain (empty) the first buffer pool 207 and that the second software partition 205 may periodically drain the third buffer pool 211.

In some examples, the first software partition 201 may acquire buffers from the first buffer pool 207 in order to store data prior to transmission. Subsequently, after transmission of the data to the second software partition 205, the hardware module 203 may release buffers back into the first buffer pool 207. In this example, as the first software partition 201 is acquiring buffers from the first buffer pool, and the hardware module 203 is releasing buffers to the first buffer pool 207, there is both a consumer and producer of buffers that advantageously operate synchronously. Therefore, in this example, draining operations may not be required, as buffers may not reach an overflow threshold.

In some other examples, the first software partition 201 may allocate new buffers or acquire buffers from a buffer pool other than the first buffer pool 207. In these examples, the hardware module 203 may still, after transmission, release buffers to the first buffer pool 207. This may result in the first buffer pool 207 reaching an overflow threshold, as the first software module 201 may be creating new buffers or acquiring buffers from other buffer pools, rather than acquiring them from the first buffer pool 207. Therefore, in these examples, there may not be a synchronous production and consumption of buffers. As a result, in some examples, it may be necessary for the first software partition 201 to perform a periodic draining procedure in order to de-allocate the memory and free up space in the first buffer pool 207.

One advantage of draining particular buffer pools is that it allows the transmitting software partition to free the particular buffer that was used during transmission, once the information has been transferred by the hardware module 203 to the particular receiving partition.

A similar operation may be performed in the reverse direction, for example if the second software partition 205 transmits data to the first software partition 201. As a result, the second software partition 205 may be required to periodically drain the fourth buffer pool 213.

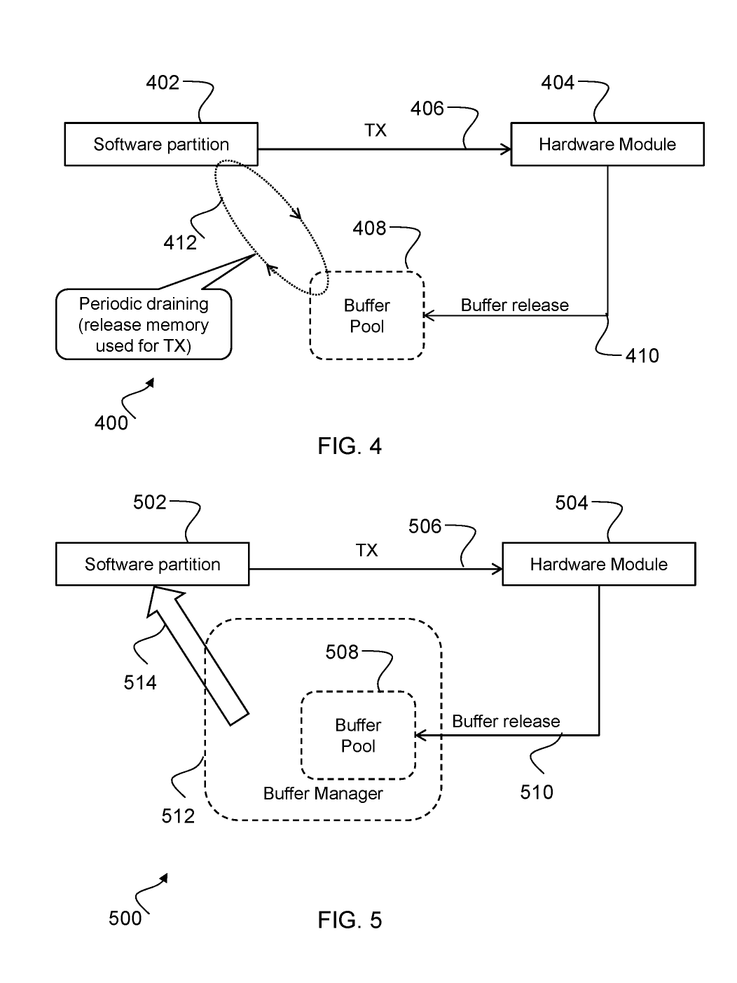

Referring to FIG. 4, a block diagram 400 illustrates a simplified buffer draining operation. In this example, part of a transmit operation between a software partition 402 and a hardware module 404 is illustrated. In this example, the software partition 402 may store data to be transmitted in a buffer acquired from buffer pool 408 and inform the hardware module 404 that data is available. The hardware module 404 may utilise the data from the buffer sourced/fetched from buffer pool 408. In some examples, buffers in buffer pool 408 may be private memory of the software partition 402, which may have been released/seeded into the buffer pool using the relevant buffer's application program interface (API) specific to the software partition 402.

After the hardware module 404 has copied data to a receiving software partition (not shown), the hardware module 404 may release the utilised buffers back into the buffer pool 408, via a ‘buffer release’ operation 410.

In this example, the buffer release operation 410 may comprise the hardware module 404 communicating with a buffer manager 229, which may be a hardware entity that manages the buffer pool(s) 408. In this example, the communication may specify those buffers that are to be released to the buffer pool 408, say by providing a buffer pool identifier. In some example, once the hardware module 404 has released the buffers, the hardware module 404 no longer keeps a reference to the buffers that were utilised.

In this example, the software partition 402 may have allocated new buffers or acquired buffers for storing data for transmission from a buffer pool other than buffer pool 408. However, the hardware module 404 may be still operable to release buffers back into buffer pool 408. Therefore, in some examples, there may be a situation whereby the buffer pool 408 becomes full of released buffers. As a result, it may be necessary for the software partition 402 to check the status of the buffer pool 408. Referring back to the implementation of FIG. 3, this scenario may not occur, since the software partition 205 may only acquire buffers from buffer pool 302, thereby preventing an overflow or filling of buffer pool 302.

In this example, the software partition 402 may regularly check an overflow threshold, which may be a threshold signifying that the buffer pool 408 is full of released buffers, and in response to the overflow threshold indicating that the buffer pool 408 is full, the software partition 402 may drain the buffer pool via a draining operation 412. Therefore, utilising this overflow operation, the buffer pool 408 may be available to the hardware module 404 for releasing buffers. In this example, the hardware module 404 is not able to de-allocate memory from the buffer pools 408. However, the hardware module 404 is operable to access the buffer pool 408.

In some examples, the memory utilised for transmission by the software partition 402 may need to be de-allocated after data has been transmitted to one or more destination software partitions. In these cases, the hardware module 404 may store a reference to the memory used for the transmission and ‘stores’ this reference in a draining buffer pool, for example buffer pool 408, such that the software partition 402 is able to obtain the reference, for example when polling buffer pools, and de-allocate the memory associated with the stored reference. Therefore, in these examples, storing data may refer to storing metadata, which may be a reference to buffers that require de-allocating. Subsequently, the software partition 402 may drain buffer pool 408 in order to make room/space for further buffers and recover the memory in use in the buffers contained by the pool. Draining buffer pools is a method whereby transmitting software partitions, for example software partition 402, are able to release memory utilised for transmission after data has been transferred, e.g. replicated/copied, to one or more receiving software partitions by the hardware module 404. The hardware module, therefore, is not generally concerned with buffer management, but configured to just utilise the buffers.

Referring to FIG. 5, block diagram 500 illustrates an alternative simplified example buffer draining operation.

In this example, after the hardware module 504 has copied data from the transmit (Tx) buffers to a receiving software partition (not shown), the hardware module 504 may release the utilised buffers back into buffer pool 508, via, say, a buffer release operation 510.

In some examples, such as the example illustrated in FIG. 4, it may not be desirable for the software partition 502 to regularly check the status of the overflow threshold, as this may require additional functionality that could be utilised on other operations. Therefore, in this example, a buffer manager 512 may register an overflow interrupt 514 if an overflow threshold is reached.

An advantage of utilising the buffer manager 512 to register an overflow interrupt 514 if a threshold is reached may be that the need for the software partition 502 to regularly check the overflow threshold is reduced. This may allow the software partition 502 to gain CPU cycles that would otherwise be utilised to regularly check the overflow threshold.

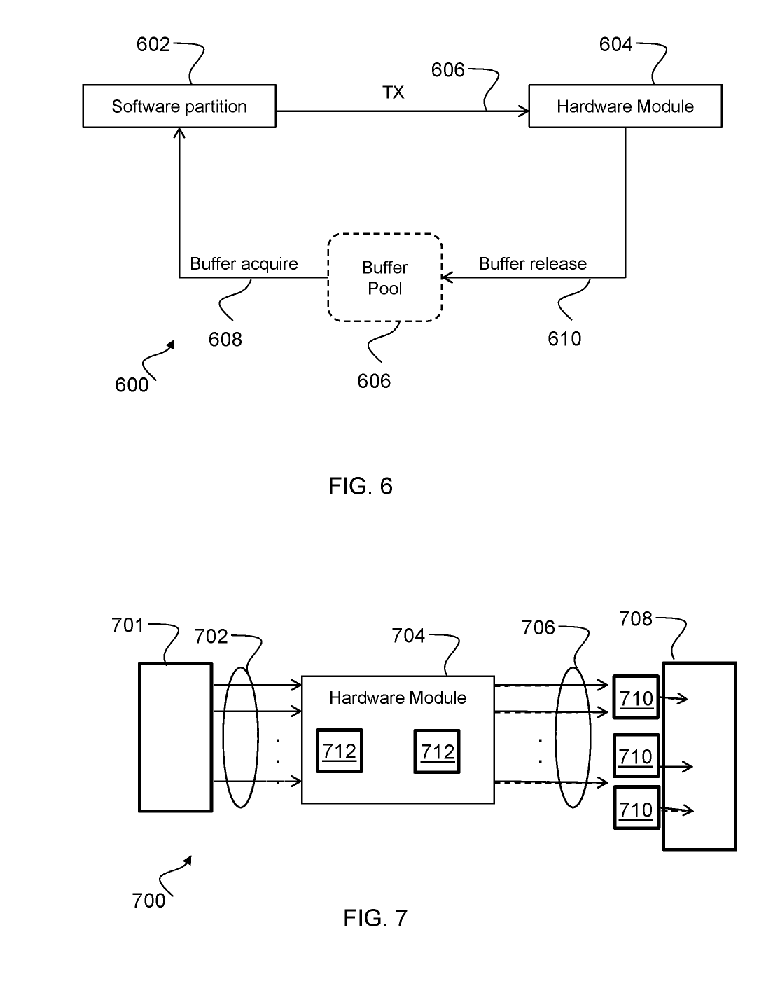

Referring to FIG. 6, block diagram 600 illustrates a yet further alternative simplified buffer operation. In this example, software partition 602 may acquire buffers from buffer pool 606 via a buffer acquire operation 608, and store data that is to be copied by hardware module 604 within the acquired buffers. In this example, the hardware module 604 may copy the stored data, and store the copied data within buffers in a receiving software partition (not shown). After the hardware module 604 has successfully copied data to the receiving software partition, the hardware module 604 may release the buffers acquired by the software partition 602 back into the buffer pool 606 utilising, say, a buffer release operation 610.

In this example, the buffer acquire operation 608 and buffer release operation 610 may be synchronous and, therefore, additional buffer draining may not be required.

Referring to FIG. 7, a simplified example block diagram illustrating input and output queues of an inter-partition communication system 700 is shown. The inter-partition communication system 700 comprises a transmitting software partition 701 outputting a number of input queues 702. The transmitting software partition 701 is operably coupled to a receiving software partition 708 via a hardware module 704, and a number of subsequent output queues 706.

In this example, the hardware module 704 is operable to receive one or more input queues 702, which may contain data to be transmitted to receiving software partition 708, and output one or more output queues 706 that may be associated with one or more buffer pools 710 owned by the receiving software partition 708. Logic 712 situated within the hardware module 704 may be operable to route incoming data, for example one or more data packets, to specific output queues and associated buffer pools based on, say, a set of preconfigured rules.

The number of input queues 702, output queues 706, associated buffer pools 710 and preconfigured rules on how to route data may be arranged as part of an initial configuration of the inter-partition communication system 700. In some examples, only certain configurations may be applied by one of the software partitions.

Initially, the transmitting software partition 701 may initialise a communications interface with hardware module 704, which may comprise allocating one or more input queues 702, through which it may communicate with the hardware module 704. In response to this, the receiving software partition 708 may allocate one or more output queues 706 and allocate buffers and group them in one or more buffer pools 710. In this example, the transmitting software partition 701 is responsible for configuring a set of rules that the hardware module 704 may utilise to transfer data to the receiving software partition 708. For example, the set of rules may comprise information relating to one or more output queues 706 and one or more buffer pools 710 to utilise for the communication. Therefore, the transmitting software partition 701 may initially preconfigure the hardware module 704 with a set of rules that may comprise information relating to which input queues 702 and output queues 708 to utilise for communications, wherein the utilised input queues 702 and output queues 706 form a communication channel between software partitions 701, 708 and the hardware module 704.

In this example, the transmitting software partition 701 may, prior to signalling a descriptor of data stored in buffers from a first buffer pool to the hardware module 704, perform an initial configuration with the hardware module 704. The initial configuration may comprise at least writing a set of classification rules in hardware, and configuring hardware to transfer data between one or more physical memory locations, for example one or more buffers.

One advantage of utilising a configuration operation with the hardware module 704 at the beginning of a transmission, for example when the system first starts, may be that only a single configuration operation may be required for subsequent transmissions. In prior art systems, such as systems utilising DMA controllers, each transfer has to be configured prior to transmission. Therefore, utilising aspects of the invention may reduce the number of CPU cycles required, via a less complex and more efficient communication methodology, for example.

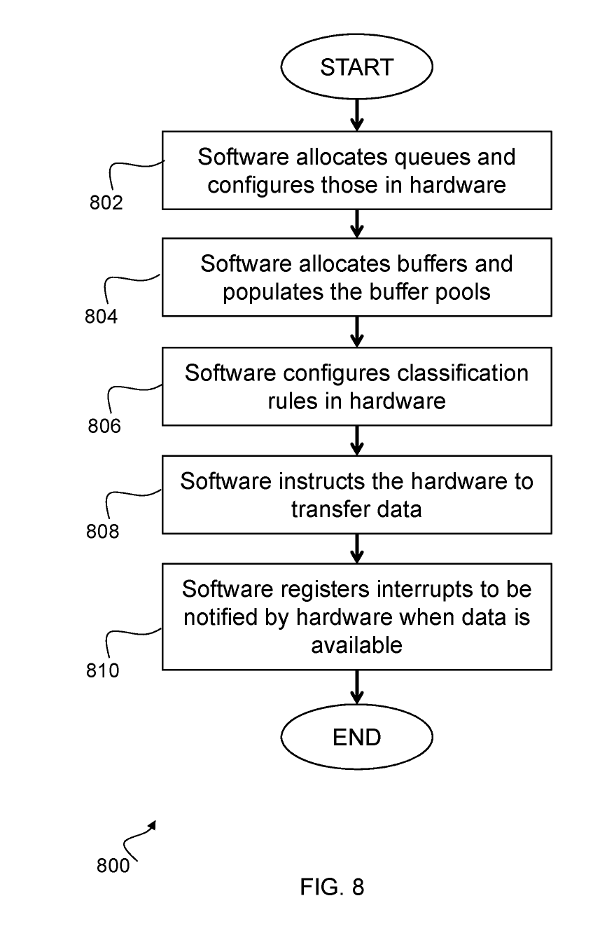

Referring to FIG. 8, a simplified example flow diagram of a configuration operation 800 is illustrated. In this example, the configuration operation 800 may only need to be performed once, say at the start of system initialisation. At 802, a transmitting software partition may allocate one or more input queues that may be utilised to communicate with a hardware module. Further, the transmitting software partition may communicate output queues to the hardware module, which may be subsequently allocated by a receiving software partition. In some examples, 802 may also be performed by a receiving software partition.

In some examples, the allocation and configuration of queues, for example frame queues, which form the communications channel between software partitions and the hardware module may be made using queue manager 227 software application programming interfaces (APIs). Further, the frame queues and their mapping between software and hardware may be specified in configuration files available in software partitions.

At 804, the receiving software partition may allocate buffers for storing information to be transmitted, and in some examples may group the allocated buffers into one or more buffer pools owned by the receiving software partition.

At 806, the transmitting software partition supplies the hardware module with a set of classification rules, pre-configuring the hardware module, which may relate to which output queues and associated buffers to utilise in the receiving partition. The set of classification rules may use criteria such as IP addresses, MAC addresses, VLAN tags etc. In some examples, 806 may also be performed by the receiving software partition.

At 808, the transmitting software partition may instruct the hardware module to copy and transfer data stored in the one or more buffers owned by the transmitting software partition to the receiving software partition. In some examples, the transmitting of data by the hardware module may comprise a replication operation. In some examples, the replication operation may allow the hardware module to transfer data from the transmitting software partition to one or multiple receiving software partitions. In some examples, 808 may also be performed by the receiving software partition.

In order to isolate memory areas of the transmitting software partition and one or more receiving software partitions, replication may be required. In these examples, replication may refer to copying data from the transmitting software partition to one or more receiving software partitions. Without replication, the transmitting and receiving software partitions would require access to each other's owned buffer pools. In this example, replication may be obtained by preconfiguring the hardware module using a series of factors, for example, one or more of: special parse/classify/distribute rules and virtual storage profiles, etc. Therefore, a high level method of configuration may be provided in any application program interface form.

At 810, the hardware module may generate one or more interrupts in order to notify the receiving software partition that data is available.

In some examples, in order to facilitate communication between software partitions and the hardware module, the following elements may need to be setup prior to actual communication. Firstly, QMan hardware may need to be configured, which defines frame queue IDs and maps these to hardware and software entities. Secondly, BMan hardware may need to be configured, which determines where buffer pools are reserved for reception, and assigns draining pools to different software partitions. Thirdly, FMan hardware may need to be configured, which may utilise a hardware module during a replication mode, ensuring software partition isolation. Configuration of the FMan may allow copying of buffer contents between source and destination buffers from distinct software partitions.

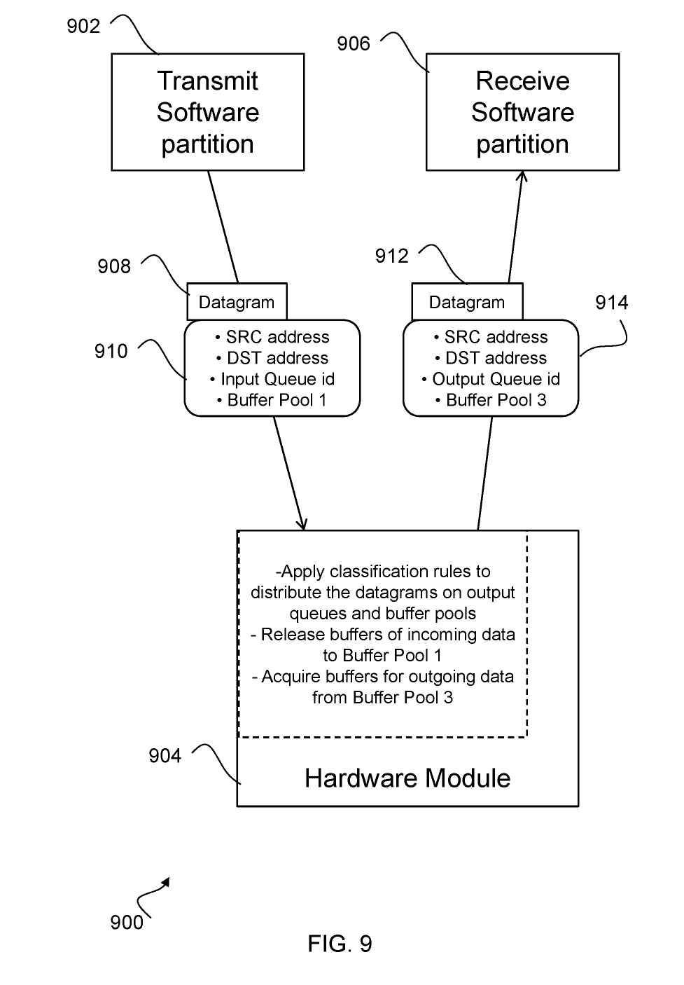

Referring to FIG. 9, a simplified example block diagram illustrates memory exchange between entities in an inter-partition communications system 900, comprising a transmitting software partition 902, a hardware module 904 and a receiving software partition 906.

In this example, communications between software partitions 902, 906 may be effected using basic transfer units such as datagrams.

Initially, the transmitting software partition 902 may prepare a datagram 908 together with a set of parameters 910. In this example, the set of parameters 910 may comprise at least one of an input queue identifier, which may be utilised in order for the transmitting software partition 902 to communicate with the hardware module 904, and a buffer pool, for example buffer pool 1, which may be utilised by the hardware module 904 to release buffers after use. Further, the set of parameters may comprise a source address and a destination address. The payload of the datagram may contain, for example, high level addressing information such as IP or MAC addresses.

In some examples, data to be transmitted by the transmitting software partition 902 may be stored in buffers acquired from buffer pool 1. In some other examples, the data to be transmitted by software partition 902 may be stored in generic memory buffers, whilst buffer pool 1 may only be utilised by the hardware module 904 to release buffers so that the transmitting software partition 902 is able to free (de-allocate) memory.

In this example, it has been assumed that the transmitting software partition 902 has already performed a classification procedure with the hardware module 904. As a result, the hardware module 904 may already comprise a set of preconfigured rules. Therefore, the hardware module 904 may be operable to apply the preconfigured classification rules to data that it has copied from relevant buffers, in order to correctly distribute the data onto correct output queues and associated buffer pools. In this example, the distribution of data may be based on logic modules within the hardware module matching various rules to parts of the datagram payload.

In this example, the hardware module 904 may acquire buffers for outgoing data from buffer pool 3, which may be owned by the receiving software partition 906, and store a copy of the data 912 in buffer pool 3, for example. In this example, a further set of parameters 914, including an output queue identifier, which may be utilised in order for the hardware module 904 to communicate with the receiving software partition, and a buffer pool, for example buffer pool 3, which may be utilised by the hardware module 904 to store a copy of the outgoing data. In response to this, the hardware module 904 may release buffers back into buffer pool 1.

When the data stored in buffer pool 3 is ready to be processed by the receiving software partition, the hardware module 904 may issue an interrupt to the receiving software partition 906, notifying the receiving software partition that data is available for use. The interrupt may comprise a reference to the buffer, which may be a memory location where the data is stored, and, as the memory area is already accessible, the receiving software partition 906 may be able to process the data and release the buffer back into the relevant buffer pool, in this example buffer pool 3, without any additional processing, for example, memory mapping, or copy of data.

An advantage of performing a single configuration procedure at the beginning of system operation with hardware module 904 is that no further configuration procedures may be required. If desired, further configuration refinements may still be possible. After initial configuration, the hardware module 904 may be able to distribute data based on preconfigured classification rules and, therefore, may not require further configuration for subsequent data transmissions. This may have an advantage of reducing CPU clock cycles when compared to a prior art process, for example a DMA system.

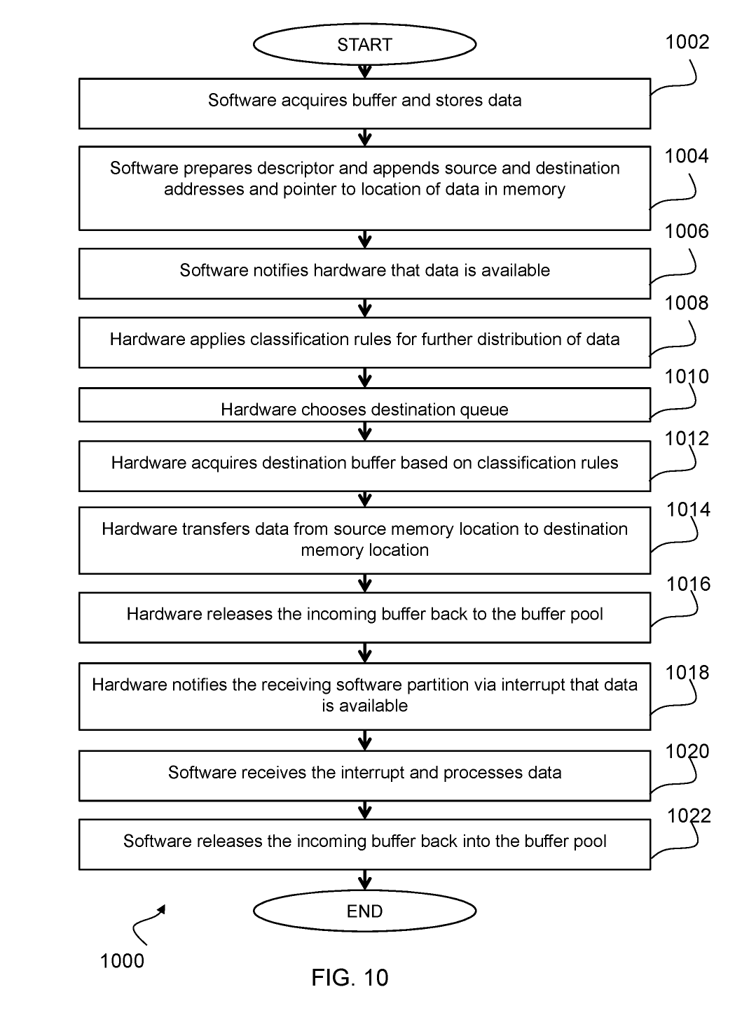

Referring to FIG. 10, an example flow chart 1000 illustrates inter-partition communication between software partitions. In this example, communication between software partitions may be carried out after an initial configuration procedure, for example the configuration procedure illustrated in FIG. 8. Initially, at 1002, a transmitting software partition may initiate a request to a software or hardware module, which may be managing one or more buffer pools, to request buffers for its own use from one or more of the buffer pools. Subsequently, the transmitting software partition may store data to be transmitted in the requested buffers. In some examples, the transmitting software partition may have allocated the buffers in the one or more buffer pools in a previous configuration procedure.

At 1004, the transmitting software partition may prepare a descriptor, which may comprise source and destination addresses and a descriptor/pointer to the location of stored data in the one or more buffers. In some examples, the source and destination addresses may relate to one or more input and output queues that are required to set up a communication channel between the transmitting software partition, hardware module and at least one receiving software partition.

At 1006, the transmitting software partition may notify the hardware module that data is available to be transmitted. In some examples, the transmitting software partition may forward the descriptor from 1004 to the hardware module via one or more input queues.

In response to this notification, the hardware module may apply a set of preconfigured classification rules at 1008, which may have been set up during a previous configuration operation, copy data from the buffers associated with the transmitting software partition, and distribute the copied data to one or more output queues and buffer(s) owned by the one or more receiving software partitions at 1010. In some examples, the hardware module may choose a destination queue based on matching various rules to parts of the data payload. In some examples, the data payload may be comprised in a datagram and, one or more logic modules within the hardware module may determine the destination, output queue(s), for the datagram.

At 1012, the hardware module may acquire one or more destination buffers, which may be owned by the one or more receiving software partitions, from the previous configuration operation. In some examples, there may be an association between the one or more output queues and one or more destination buffer(s). Further, in this example, the transmitting software partition may be responsible for determining input queues to communicate with the hardware module, output queues to enable the hardware module to communicate with one or more receiving partitions, and/or one or more buffers owned by the one or more receiving partitions. In order for the hardware module to acquire destination buffers, it may be necessary for the one or more receiving software partitions to allocate the buffers into one or more buffer pools before the hardware module is able to acquire the one or more buffers.

At 1014, the hardware module may transfer the copied data, from the source memory location, e.g. allocated buffers owned by the transmitting software partition, to one or more destination memory locations, e.g. allocated buffers owned by the one or more receiving software partitions. In some examples, the process of transferring copied data from the source memory location to the destination memory location(s) may comprise replication. In this example, replication may be utilised in order to isolate memory locations between software partitions. Replication may be set up during the previous configuration operation of the hardware module. Without a replication step performed by the hardware module, buffers owned by the transmitting software partition would need to be accessible to the one or more receiving partitions, e.g. the destination operating system would need to access memory allocated by the source operating system. Therefore, there would not be any isolation in this example scenario.

Utilising replication, data stored in the buffers owned by the transmitting software partition may be copied by the hardware module to the one or more destination memory locations owned by the one or more receiving software partitions. Utilising this procedure, there is no shared memory between different software partitions and, therefore, memory locations owned by respective software partitions would not be accessed by other software partitions, thereby providing isolation.

As discussed above, the hardware module may require configuration prior to replication. In some examples, the hardware module may be configured during a previous configuration procedure. In some examples, a series of factors may be configured to facilitate the replication procedure within the hardware module. For example, factors may comprise one or more of: special parse/classify/distribute rules and/or virtual storage profiles. In some examples, all low level details may be abstracted away by drivers' API(s), thereby providing a high level method of configuration in the form of a software API.

At 1016, the hardware module may release the buffers used to store data for transmission back into corresponding buffer pools owned by the transmitting software partition, now that data has been transferred and replicated to one or more receiving software partition's allocated memory locations. Releasing buffers back into corresponding buffer pools may require the hardware module to communicate with a buffer manager (BMan), specifying the buffers to be added to certain buffer pools usually by providing a buffer ID. In this case, the releasing of buffers is from the hardware module's perspective. I.e. the hardware module passes its reference to the buffers back to the BMan. De-allocation may then be performed by relevant software partitions.

In some examples, if the release of buffers back into the transmitting software partition's buffer pools causes an overflow threshold to be exceeded, the transmitting software partition may initiate a buffer draining operation to de-allocate buffers from the buffer pools. In some examples, exceeding the overflow threshold may be signalled to the transiting software partition via an interrupt. In other examples, the transmitting software partition may periodically check the status of the overflow threshold to determine when the threshold is reached.

At 1018, the hardware module may have stored a copy of the data from the transmitting software partition into memory locations, buffers, acquired by the hardware module, but allocated by the receiving software partition. As a result, the hardware module may notify the receiving software partition once the copy of the data is available in the allocated buffers. In some examples, the hardware module may issue an interrupt to the receiving software partition, which may comprise notification that data is available, and in some examples identify a reference to the memory location of the buffer(s) storing the data.

At 1020, the receiving software partition may receive the interrupt issued by the hardware module and process the data from the reference given in the interrupt.

At 1022, the receiving software partition may release the acquired buffers back into the associated buffer pool. In this example, as the memory comprises buffers that are already accessible, the receiving software partition may be operable to release the buffers back into the buffer pool without any additional processing required, for example memory mapping, copying of data, etc.

An advantage of utilising aspects of the invention is that a hypervisor, or equivalent entity, is not required. Further, shared memory regions are not required, allowing secure communications between different software partitions. As a result, a CPU's intervention may be reduced, leading to an increase in gained clock cycles. Furthermore, as shared memory regions may not be required, buffers owned by particular software partitions are only accessible by those software partitions. Therefore, memory isolation between software partitions can be effected. Further, each software partition does not need to known the destination memory address of a receiving software partition's buffers during communication.

Further, utilising aspects of the invention, configuration of a hardware module is only required when the system starts. Therefore, no further configurations may need to be made by software partitions during transmission, thereby potentially reducing the number of CPU clock cycles required.

Utilising aspects of the invention may eliminate the need for software partitions to program the hardware module each time a transfer of data is initiated.

The invention may also be implemented in a computer program for running on a microprocessor system, at least including code portions for performing steps of a method according to the invention when run on a programmable apparatus, such as a microprocessor system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a tangible and non-transitory computer readable storage medium or transmitted to the microprocessor system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a microprocessor system and provides programmers with an interface used to access those resources. An operating system processes system data and user input, and responds by allocating and managing tasks and internal system resources as a service to users and programs of the system.

The microprocessor system may for instance include at least one processing unit, associated memory and a number of input/output (I/O) devices. When executing the computer program, the microprocessor system processes information according to the computer program and produces resultant output information via I/O devices.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being “operably connected,’ or ‘operably coupled’, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device within any multiprocessor device. Alternatively, the examples may be implemented as any number of separate integrated circuits or separate devices interconnected with each other in a suitable manner within any multiprocessor device.

Also for example, the examples, or portions thereof, may be implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’, or ‘an’, as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an’. The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A communication system, comprising:
a plurality of software partitions operably coupled to one another via at least one hardware module comprising a buffer manager, wherein each of the plurality of software partitions comprises memory allocated to store data for use solely by the respective software partition,
which hardware module is arranged to copy data from a first memory location of a first software partition to second memory location of a second software partition wherein the second memory location is selected by the buffer manager.

2. The communication system of claim 1, wherein a first software partition of the plurality of software partitions is arranged to configure the hardware module with a set of instructions.

3. The communication system of claim 2, wherein the set of instructions comprise at least one of: one or more classification rule(s) for transfer of data; one or more input queue(s) to use for transfer of data with the first software partition; one or more output queue(s) to use for communication with the first software partition; one or more buffer pools to use for communication with the first software partition.

4. The communication system of claim 3, wherein the one or more classification rule(s) for transfer of data comprises instructions to the hardware module to parse, classify and distribute data frames between software partitions.

5. The communication system of claim 3, wherein the hardware module is arranged to receive from the first software partition a descriptor of data stored in buffers from a first buffer pool of the first software partition and apply a previously received classification rule to distribute data to at least one identified output queue(s).

6. The communication system of claim 1, wherein the hardware module is further arranged to:
fetch data pointed to by a first software partition,
make a copy of the data, and
distribute the copied data to a buffer from a second buffer pool of a second software partition of the plurality of software partitions.

7. The communication system of claim 6, wherein the distribution of copied data is based on the hardware module matching at least one rule to at least a part of a datagram payload.

8. The communication system of claim 6, wherein the hardware module is further arranged to store the copied data in a buffer from a third buffer pool of the second software partition for processing by the second software partition.

9. The communication system of claim 6, wherein the hardware module is further arranged to issue an interrupt to the second software partition that notifies the second software partition that data is available.

10. The communication system of claim 9, wherein the interrupt comprises a reference to the buffer from the third buffer pool and a memory location of the buffer holding the stored data.

11. The communication system of claims 8, wherein at least one of the second software partition, the hardware module is arranged to release the buffer holding the stored data back into the third buffer pool after the data has been processed by the second software partition.

12. The communication system of claim 1, wherein at least one software partition of the plurality of software partitions is arranged to de-allocate buffers from buffer pools of the software partition.

13. The communication system of claim 12, wherein the at least one software partition periodically de-allocates buffers from the buffer pools.

14. The communication system of claim 1, wherein at least one software partition comprises a single buffer pool configured to support both transmit data frames and receive data frames.

15. The communication system of claim 1, wherein a first software partition acquiring at least one buffer from a first buffer pool of the first memory location, and the hardware module 203 releases at least one buffers to the first buffer pool.

16. The communication system of claim 1, wherein at least one software partition of the plurality of software partitions is arranged to perform a draining operation of data from the first memory location of the first software partition.

17. The communication system of claim 16, wherein the at least one software partition is arranged to periodically drain at least one descriptor from a buffer pool of the first memory location of the first software partition.

18. A method of transferring data in a communication system, comprising a plurality of software partitions operably coupled to one another via at least one hardware module comprising a buffer manager, wherein each of the plurality of software partitions comprises memory allocated to store data for use solely by the respective software partition, wherein the method comprises:
instructing the at least one hardware module to transfer data from a first memory location of a first software partition to second memory location of a second software partition;
selecting, by the buffer manager, the second memory location to receive the data from the first memory location; and
copying, by the at least one hardware module, data from the first memory location of the first software partition to the second memory location of the second software partition.

19. The method of claim 18, further comprising configuring the at least one hardware module with a set of instructions by a first software partition of the plurality of software partitions.

20. The method of claim 18, further comprising the hardware module:
fetching data pointed to by a first software partition,
making a copy of the data, and distributing the copied data to a buffer from a second buffer pool of a second software partition of the plurality of software partitions.
